(19) United States
(12) Patent Application Publication
(10) Pub. No.: US 2025/0369625 A1
(43) Pub. Date: Dec. 4, 2025

(54) GREASE MANAGEMENT SYSTEM FOR A GRILL

(71) Applicant: Sawyer JOACHIM, Amery, WI (US)

(72) Inventor: Sawyer JOACHIM, Amery, WI (US)

(21) Appl. No.: 19/222,565

(22) Filed: May 29, 2025

Related U.S. Application Data
(60) Provisional application No. 63/653,635, filed on May 30, 2024.
(60) Provisional application No. 63/666,955, filed on Jul. 2, 2024.

(51) Int. Cl. F24C 15/14; A47J 37/07

(52) U.S. Cl. CPC F24C 15/14; A47J 37/0786

(57) ABSTRACT

A grease management includes a grease receptacle including an interior and an opening; an enclosed tubular conduit including an open receiving end and an open distal end and a length therebetween, the receiving end arranged to receive material from a cooking grill, and the distal end arranged to direct the material to the opening of the grease receptacle; a bracket including a first attachment mechanism arranged to couple the receiving end to the cooking grill, and a second attachment mechanism arranged to couple the grease receptacle to the bracket and the enclosed tubular conduit.

### PRIORITY APPLICATION(S)

This application claims the benefit of U.S. Provisional Application Nos. 63/653,635, filed 30 May 2024 and 63/666,955 filed 2 Jul. 2024, the disclosures of which are incorporated by reference herein in their entireties.

### FIELD

The present disclosure relates to devices, systems, and methods for managing grease from cooking grills. The present disclosure further relates to grease management systems that receive and contain grease from cooking grills.

### BACKGROUND

When foods (in particular, meats) are cooked, they may release grease, cooking fluids, etc. It may be desirable to collect and contain the released grease and cooking fluids. Certain styles of grills include an opening or grease outlet. It would be desirable to provide a system that collects and contains the grease and cooking fluids from the grill.

The design of the current solutions suffers from several challenges such as being disposed to spills from inadvertent contact with people or objects, as well as from water sources such as rain, sprinklers, or garden hoses. These spills can result in grease creating potential slipping hazards and attracting insects and animals. There is also a risk of burns from accidental contact with the hot fluids, particularly for children and pets.

Therefore, a need exists for a safe system to collect fluids from a grill or any outdoor cooking device. Further, a need exists to enhance stability to prevent spilling of the fluids. Additionally, a need exists to prevent burns from accidental contact with the containment system and to reduce the risk of fires.

### SUMMARY

Devices, systems, and methods for managing grease from cooking grills are provided. The grease management includes a grease receptacle including an interior and an opening; an enclosed tubular conduit including an open receiving end and an open distal end and a length therebetween, the receiving end arranged to receive material from a cooking grill, and the distal end arranged to direct the material to the opening of the grease receptacle; a bracket including a first attachment mechanism arranged to couple the receiving end to the cooking grill, and a second attachment mechanism arranged to couple the grease receptacle to the bracket and the enclosed tubular conduit.

The bracket may be constructed to maintain the grease receptacle at a height of 1 cm or greater measured from a floor or ground below the grease receptacle. The enclosed tubular conduit may have a shape and size that reduces or minimizes clogging. The enclosed tubular conduit may be flexible. The enclosed tubular conduit may have an accordion structure. The enclosed tubular conduit may have a funnel-shaped receiving end.

In some embodiments, the grease management system includes a grease receptacle comprising an interior and an opening; an enclosed tubular conduit including an open receiving end and an open distal end and a length therebetween, the receiving end arranged to receive material from a cooking grill, and the distal end arranged to direct the material to the opening of the grease receptacle; a bracket including a first attachment mechanism arranged to couple the receiving end to the cooking grill; and a second attachment mechanism disposed on or extending from the enclosed tubular conduit and arranged to couple the grease receptacle to the enclosed tubular conduit. The second attachment mechanism may include a U-shaped slot constructed to receive an end of an extension extending from the grease receptacle.

A method of using a grease management system includes coupling the first attachment mechanism with a cooking grill to arrange the receiving end to receive material from the cooking grill, and coupling the handle of the grease receptacle with the second attachment mechanism, such that the open distal end of the enclosed tubular conduit extends through the opening of the grease receptacle.

The above summary is not intended to describe each embodiment or every implementation. Rather, a more complete understanding of illustrative embodiments will become apparent and appreciated by reference to the following Detailed Description and claims in view of the accompanying figures of the drawing.

### BRIEF DESCRIPTION OF FIGURES

FIG. 1 shows a schematic perspective view of a grease management system according to an embodiment of the present disclosure.

FIG. 2 is a schematic perspective view of the grease management system of FIG. 1.

FIG. 3A is a schematic perspective view of the grease receptacle of the grease management system of FIG. 1.

FIG. 3B is a schematic perspective view of another embodiment of a grease receptacle for the grease management system of FIG. 1.

FIG. 4A is a schematic perspective view of the lid of the grease receptacle of FIG. 3A.

FIG. 4B is a schematic perspective view of the lid of the grease receptacle of FIG. 3B.

FIG. 5 is a schematic perspective view of the conduit of the grease management system of FIG. 1.

FIG. 6 is a schematic perspective view of the conduit of the grease management system of FIG. 1 according to an embodiment.

FIG. 7 is a schematic perspective view of a conduit with a funnel-shaped receiving end for the grease management system of FIG. 1 according to an embodiment.

FIG. 8 is a schematic side view of an accordion side wall of a conduit for the grease management system of FIG. 1 according to an embodiment.

FIG. 9A is a schematic side view of the bracket of the grease management system of FIG. 1.

FIG. 9B is a schematic front view of the bracket of FIG. 9A.

FIG. 10A is a schematic side view of an alternative bracket for the grease management system of FIG. 1 according to an embodiment.

FIG. 10B is a schematic front view of the bracket of FIG. 10A.

FIG. 11 is a schematic perspective view of an alternative bracket and attachment mechanism for the grease management system of FIG. 1 according to an embodiment.

FIG. 12A is a schematic side view of an alternative bracket for the grease management system of FIG. 1 according to an embodiment.

FIG. 12B is a schematic front view of the bracket of FIG. 12A.

FIG. 13A is a schematic perspective view of an alternative bracket and conduit for the grease management system of FIG. 1 according to an embodiment.

FIG. 13B is a schematic side view of the bracket and conduit of FIG. 13A.

FIG. 14 is a schematic exploded view of the bracket and conduit of FIG. 13A.

FIG. 15 is a schematic side view of a grease receptacle supported by a shelf according to an embodiment.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

It should be noted that, as used here, like reference numbers refer to like elements throughout the various views in the drawings.

### Definitions

All scientific and technical terms used herein have meanings commonly used in the art unless otherwise specified. The definitions provided herein are to facilitate understanding of certain terms used frequently herein and are not meant to limit the scope of the present disclosure.

The term “about” is used here in conjunction with numeric values to include normal variations in measurements as expected by persons skilled in the art, and is understood to have the same meaning as “approximately” and to cover a typical margin of error, such as ±5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

The terms grease and liquid are used here interchangeably to refer to any grease, fat, oil, cooking fluids, and other food byproducts collectively that may be released or detached from foods being cooked on the grill. Collectively, the grease and other liquid, along with possible food particles and other materials, are referred to here as accumulated material.

### DETAILED DESCRIPTION

The present disclosure relates to devices, systems, and methods for managing grease from cooking grills. In particular, the present disclosure relates to grease management systems that receive and contain grease from cooking grills.

Certain types of cooking grills and certain types of foods, when cooked on such grills, may result in the accumulation of grease, liquids, and particulates from the foods on the grill's cooking surface. The particulates may include bits of raw, cooked, or charred food material. Such accumulated material may be removed, for example, by scraping the surface and pushing the accumulated material to the back of the grill and/or off of the cooking surface. Some grills may include an opening at the back of the grill that enables removal of the accumulated material from the cooking surface. The material may be collected in a receptacle. Existing receptacles suffer from multiple drawbacks, such as the small capacity of the receptacle attached to the grill, or the receptacle being positioned on the ground and being subject to accidental or undesired contact by people, animals, or objects, including users, children, pets, or pests. Such accidental or undesired contact may cause spills, contact with hot contents, and/or contamination of the contents with water or contamination of other things with the contents. Receptacles distanced from the grill suffer from a narrow conduit that may become easily clogged.

The device of the present disclosure may help reduce or minimize the likelihood of clogging of the conduit with the accumulated material, such as grease and particulates. The device may help avoid spills from inadvertent contact with people or objects, as well as from water sources such as rain, sprinklers, or garden hoses. The device may also help avoid a risk of burns from inadvertent contact with the hot contents of the receptacle, particularly for children and pets. The device may provide burn safety and spill prevention, while still allowing efficient collection of the grease and other fluids from the cooking grill. Additionally, the device keeps the grease receptacle away from the floor or the ground allowing outdoor cooking devices to have desirable features such as mobility and portability.

Embodiments of the present invention are directed to various devices, systems, and methods for managing unwanted food byproducts such as grease and other liquids and accumulated material from a cooking grill. According to an embodiment, a grease management system includes a grease receptacle, a conduit arranged to direct accumulated material to the grease receptacle, and a bracket constructed to couple the grease receptacle and/or conduit to a cooking grill.

The grease receptacle is constructed to receive accumulated material (e.g., grease or other liquids) from a cooking grill. The cooking grill may include an opening in its housing through which the accumulated material may exit during or after cooking on the grill. In some embodiments, the grill may have a griddle cooking surface, and the opening in the housing may direct the accumulated material off of the griddle cooking surface. The grease receptacle may be positioned below the opening in the housing of the griddle so that the accumulated material flow along the surface of the opening in the housing and into the grease receptacle.

The grease receptacle has a sidewall, a top, and a bottom. The top may be an open top or may include an opening. In the embodiment shown, the top is an open top. The side wall defines an interior having an interior volume. The grease receptacle may have any suitable interior volume. For example, the interior volume may range from 1 L to 30 L. The grease receptacle may have any suitable shape. For example, the grease receptacle may be cylindrical, frustoconical, cuboidal, etc. In some embodiments, the grease receptacle is cylindrical or frustoconical. The grease receptacle may be covered by a lid or cover. The lid or cover may be removably attached to the grease receptacle. The lid or cover may attach by a snap fit, friction fit, threaded fit, or the like, or may simply rest on top of the grease receptacle. The lid or cover may include a rim. The rim may facilitate attaching the lid or cover to the grease receptacle. The lid or cover includes an opening. The opening is a through hole extending through the lid or cover. The opening allows the accumulated material to pass through the cover or the lid into the grease receptacle. The grease receptacle may be constructed of any suitable material. In one or more embodiments, the grease receptacle is constructed from thermally insulating material to slow down the transfer of heat through the walls of the grease receptacle. The grease receptacle may be constructed with thermally insulated walls or with thermal insulation around its walls. In one or more embodiments, the grease receptacle may be constructed of a polymer. The grease receptacle may include parts that are made of non-polymeric materials, such as metal, glass, cellulosic materials, etc.

The grease receptacle is constructed to receive liquids and accumulated material (e.g., grease) from a cooking grill. The cooking grill may include an opening in the housing in its housing through which such accumulated material may exit during or after cooking on the grill. The opening in the housing may be positioned at the back of the grill. Alternatively, the opening in the housing may be in another location, such as at a side, bottom, or the front of the grill. In some embodiments, the grill may have a griddle cooking surface, and the opening in the housing may direct the accumulated material off of the griddle cooking surface. The grease management system includes a conduit arranged to direct the accumulated material from the opening in the housing to the grease receptacle. In an embodiment, the opening in the housing may include a sloped surface extending toward the conduit. The opening in the housing may be sized and configured to receive grease and other food byproducts from the cooking grill and direct them toward the conduit.

The conduit is arranged to direct the accumulated material from the opening in the housing to the grease receptacle. The conduit may have a first open end or a receiving end, and a second open end or a distal end. In an embodiment, the conduit is an enclosed conduit. That is, the conduit is closed along its length between the open ends. The conduit may have a tubular structure. The conduit may include a tubular side wall. The tubular side wall may have a circular cross-section, as shown, or may be any other shape, such as rectangular, square, oval, etc. The tubular side wall extends from a first end to a second end. The conduit has a length and an inner diameter. The length may range from 10 cm to 80 cm, from 10 cm to 75 cm, from 15 to 70 cm, from 20 cm to 65 cm, or from 30 cm to 50 cm. The inner diameter may range from 2.5 cm to 20 cm, from 5 cm to 15.5 cm, or from 7 cm to 12 cm. Beneficially, the length and/or the diameter may be selected such that the accumulated material (that typically includes grease) cools as it flows through the conduit but, on the other hand, even when the grease cools, it will not clog the conduit. Cooling of the material also reduces the risk of burns if a person or an animal would come in contact with the grease receptacle. Further, according to an embodiment, the length is selected such (e.g., greater than 20 cm) that the accumulated material cools enough before falling into the grease receptacle to allow the grease receptacle to be made of economical polymers, such as polypropylene, polyethylene, or the like, or the use of a liner, such as a plastic bag. This feature may further be particularly useful when the grease receptacle and/or a liner is made of a biopolymer or a biodegradable material (e.g., PLA or other biopolymer/biodegradable polymer), as such polymers may have a lower heat tolerance.

In one or more embodiments, the open distal end of the enclosed tubular conduit may extend through the opening of the grease receptacle. In an embodiment, the receiving end of the enclosed tubular conduit may be shaped like a funnel. A funnel configuration of the receiving end may allow a wider opening in the housing on the cooking grill to streamline into a narrower opening of the grease receptacle.

In one or more embodiments, the conduit is flexible. The flexible structure of the conduit may allow it to bend and flex without kinking or collapsing. A flexible conduit is also amenable to navigating around any structural obstacles. The flexibility of the conduit may also be useful in allowing the cooking grill to be mobile. The flexible structure of the conduit may accommodate the movement of the cooking grill without incurring any damage to the grease management system. In one or more embodiments, the conduit may have an accordion structure. An accordion structure adds to the flexibility of the conduit by allowing it to compress and expand, thus allowing it to adapt to varying lengths and rendering it adaptable to tight spaces. Accordingly, the conduit may be constructed of any suitable material. In one or more embodiments, the conduit may be constructed of a polymer. The conduit may be constructed of a thermally resistive polymer. The conduit may include parts that are made of non-polymeric materials, such as metal, glass, cellulosic materials, etc. In some embodiments, the conduit is constructed of a metal.

The grease management system includes a bracket constructed to couple the grease receptacle and/or conduit to the cooking grill. The bracket is constructed to couple the grease receptacle and/or conduit to the grill. The bracket is constructed to hold the grease receptacle above the ground, at a certain height as measured from the bottom of the grease receptacle. Holding the grease receptacle above the ground may allow the cooking grill to be mobile and portable. In one or more embodiments, the bracket may be constructed to maintain the grease receptacle at a height of 1 cm or greater, 1.5 cm or greater, 2 cm or greater, 2.5 cm or greater, or 3 cm or greater, measured from a floor or ground below the grease receptacle. Maintaining the grease receptacle at an optimum height above the ground or floor below the receptacle may be beneficial in case of uneven floor or ground and may help maintain the grease maintenance system spill-proof.

The bracket may include one or more attachment mechanisms that attach the bracket to the grill and attach one or both of the grease receptacle and conduit to the bracket and thus, indirectly, to the grill. The bracket may include a first attachment mechanism for attaching the bracket to the grill. The first attachment mechanism may extend in a first direction from the bracket while the open receiving end of the conduit may extend in a second direction opposite of the first direction. In one or more embodiments, the first attachment mechanism may be a hook. The hook may extend from the body of the bracket. The hook may be constructed to latch onto the grill. For example, the hook may be constructed to latch onto the backside of the grill at or below the opening in the housing.

The bracket may include a second attachment mechanism for attaching the bracket to the grease receptacle. The second attachment mechanism may include a chain, wire, or an extension of the bracket. In some embodiments the second attachment mechanism includes a second hook at the lower end of the bracket body and a handle on the grease receptacle. The handle may be constructed to be received by the second hook. In embodiments, the second attachment mechanism is positioned below the first attachment mechanism.

The bracket may include a third attachment mechanism for securing the receiving end (e.g., the first end) of the conduit to the bracket. The third attachment mechanism is not particularly limited and may include one or more of a nut and bolt, a rivet, interlocking hooks, a hook and loop, a weld, or any other suitable mechanism.

In some embodiments, the bracket may include a first attachment mechanism arranged to couple the receiving end of the conduit to the cooking grill, a second attachment mechanism arranged to couple the conduit to the bracket, and a third attachment mechanism disposed on or extending from the enclosed tubular conduit and arranged to couple the grease receptacle to the conduit. The third attachment mechanism may include two U-shaped slots constructed to each receive an end of an extension extending from the grease receptacle. The two U-shaped slots may be positioned on opposite sides of the conduit. A lid constructed to couple with the opening of the grease receptacle may be attached to the third attachment mechanism.

Two or more of the parts of the grease management system may be integrally formed or fixedly attached. Fixed attachments include attachments that cannot be detached without damage to the part or the attachment itself. Examples of fixed attachments include welding and adhesives. For example, the bracket may be integral with or fixedly attached to the conduit. In some embodiments, the bracket is integral with the conduit. The various attachments may be integral with or fixedly attached to the bracket and/or with the part they connect to (e.g., the conduit, the lid, or the grease receptacle). In embodiments where the bracket is integral with the conduit, one or more of the attachment mechanisms may be directly connected to the conduit. The lid or cover may be integral with or fixedly attached to the conduit.

In some embodiments, the grease management system includes one or more disposable parts. For example, the entire grease management system or the grease receptacle may be disposable. That is, the entire grease management system or the grease receptacle may be intended to be used until the grease receptacle is full and then be disposed. In some such embodiments, one or more parts of the grease management system or the grease receptacle may be made of a biopolymer (e.g., polylactic acid (PLA) or similar). In some embodiments, one or more parts of the grease management system or the grease receptacle may be made of a biodegradable material (e.g., biodegradable PLA or cellulose-based material). In some embodiments, the grease receptacle includes a liner, e.g., a disposable liner that may be discarded once full.

A method of using a grease management system includes a grease receptacle including an interior, an opening, and a handle, and a conduit including a first end or an open receiving end and a second end or an open distal end and a length therebetween, a bracket comprising a first attachment mechanism and a second attachment mechanism. The method further includes coupling the first attachment mechanism with a cooking grill to arrange the receiving end to receive accumulated material from the cooking grill. The method further includes coupling the grease receptacle with the bracket or with the conduit such that a second end of the conduit directs flow of material from the grill into the interior of the grease receptacle. In some embodiments, coupling the grease receptacle with the bracket includes receiving the handle of the grease receptacle in the second attachment mechanism, such that the open distal end of the conduit extends through the opening of the grease receptacle. The method of using the grease management system may further include directing accumulated material (e.g., grease and food particles) from the cooking grill into the open receiving end of the conduit. This may include pushing the accumulated material with a tool into the open receiving end of the conduit. The accumulated material may then fall through the conduit and into the grease receptacle.

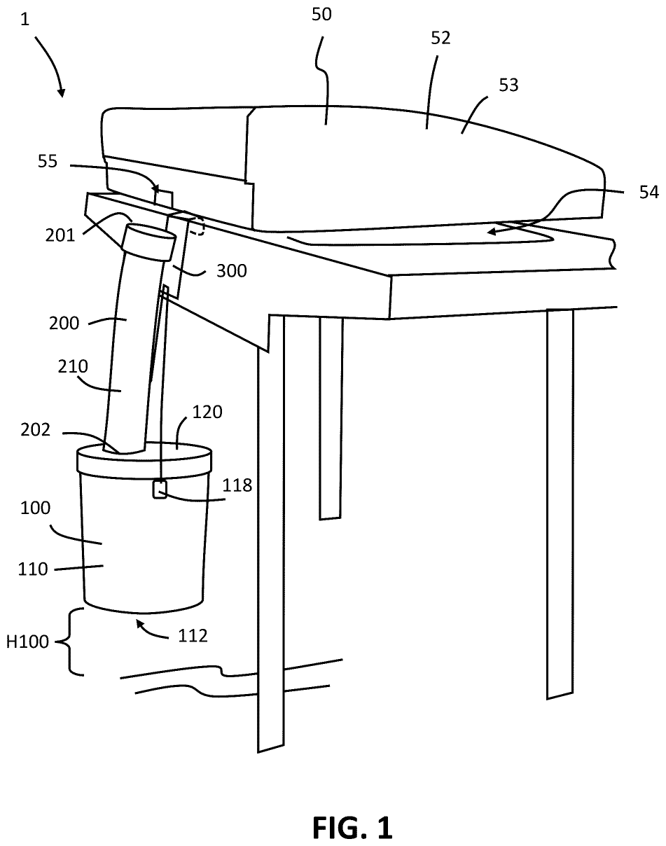

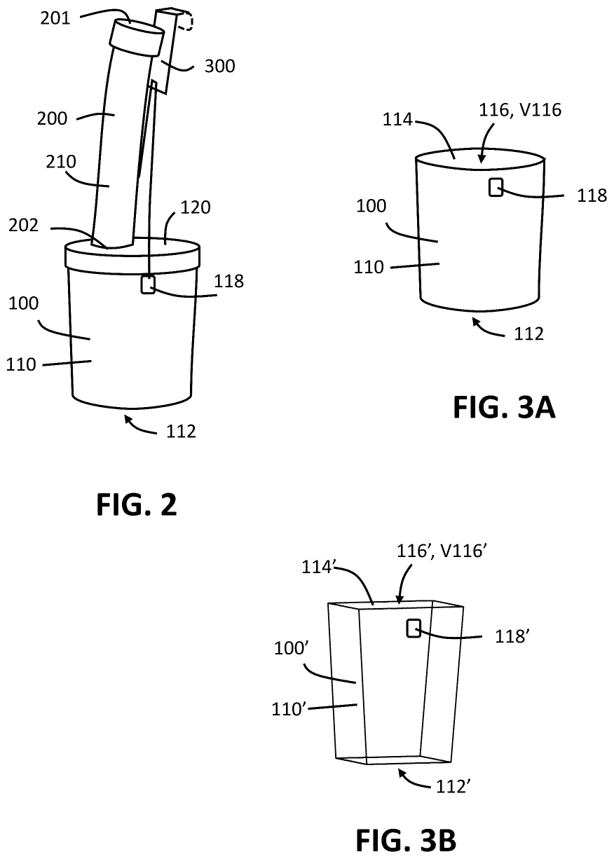

Referring now to FIGS. 1-5, an exemplary embodiment of the grease management system 1 is shown. The grease management system 1 includes a grease receptacle 100. The grease receptacle 100 is constructed to receive accumulated material (e.g., grease and food particles) from a cooking grill 50. The cooking grill 50 may include a housing 52 with a top 53 constructed to cover a cooking surface 54, and an opening 55 in the housing 52 through which such accumulated material may exit during or after cooking on the grill. The opening 55 in the housing 52 may be positioned at the back of the grill 50. Alternatively, the opening 55 in the housing 52 may be in another location, such as at a side, bottom, or the front of the grill 50. In some embodiments, the grill 50 may have a griddle-type cooking surface 54, and the opening 55 in the housing 52 may direct the accumulated material off of the griddle-type cooking surface 54.

The grease management system 1 includes a conduit 200 arranged to direct the accumulated material from the opening 55 in the housing 52 to the grease receptacle 100. The grease management system 1 further includes a bracket 300. The bracket 300 is constructed to couple the grease receptacle 100 and/or conduit 200 to the grill 50. The bracket 300 is constructed to hold the grease receptacle 100 above the ground, for example, at a height of H100 as measured from the bottom 112 of the grease receptacle 100.

The grease receptacle 100 has a side wall 110, as shown in FIG. 3A. The grease receptacle 100 has a top 111 and a bottom 112. The top 111 may be an open top 114 or may include an opening. In the embodiment shown, the top 111 is an open top 114. The side wall 110 defines an interior 116 having an interior volume V116. The grease receptacle 100 may have any suitable interior volume V116. For example, the interior volume V116 may range from 1 L to 30 L. The grease receptacle 100 may have any suitable shape. For example, the grease receptacle 100 may be cylindrical, frustoconical, cuboidal, rectangular, etc. In some embodiments, the grease receptacle 100 is cylindrical or frustoconical. In some embodiments, as shown in FIG. 3B, the grease receptacle 100′ has a side wall 110′ and bottom 112′, forming a rectangular cross-sectional shape in a horizontal cross section. This may save space by allowing the cooking grill 50 to be placed near or against a wall or other structure. The grease receptacle 100′ also includes an open top 114′, an interior 116′, and an interior volume V116′, similar to the cylindrical grease receptacle 100 of FIG. 3A.

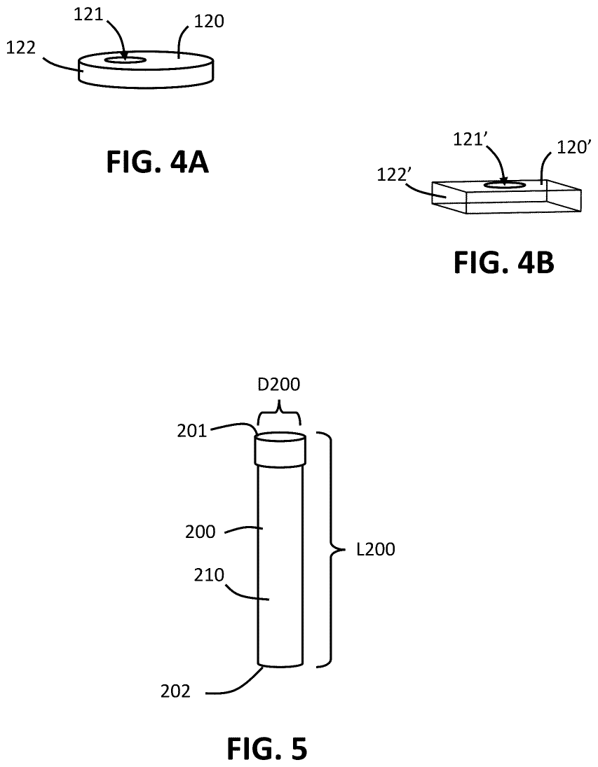

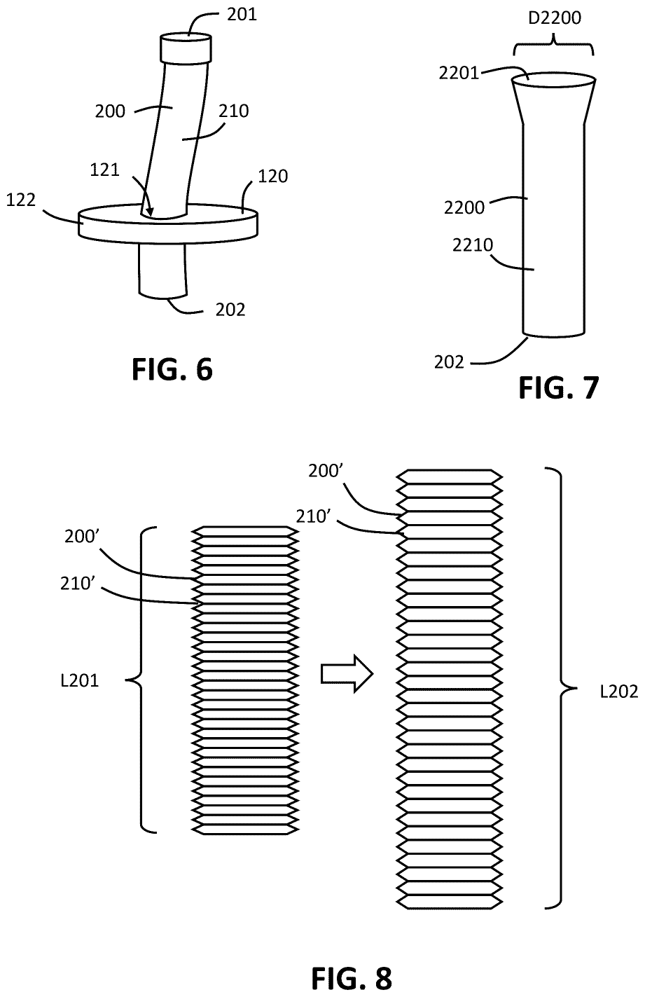

The grease receptacle 100 may be covered by a lid or cover 120, as shown in FIGS. 4A (circular lid or cover 120 configured for a cylindrical grease receptacle 100) and 4B (rectangular lid or cover 120′ configured for a rectangular grease receptacle 100′). The lid or cover 120, 120′ may be removably attached to the grease receptacle 100, 100′. The lid or cover 120, 120′ may attach by a snap fit, friction fit, threaded fit, or the like, or may simply rest on top of the grease receptacle 100, 100′. The lid or cover 120, 120′ may include a rim 122, 122′. The rim 122, 122′ may facilitate attaching the lid or cover 120, 120′ to the grease receptacle 100, 100′. The lid or cover 120, 120′ includes an opening 121, 121′. The opening 121, 121′ is a through hole extending through the lid or cover 120, 120′. The opening 121, 121′ allows the accumulated material to pass through the lid or cover 120, 120′ into the grease receptacle 100, 100′. In some embodiments, as shown in FIG. 6, the conduit 200 extends through the opening 121.

The conduit 200 directs the accumulated material from the opening 55 in the housing 52 in the cooking grill 50 to the grease receptacle 100. In a preferred embodiment, the conduit 200 is an enclosed conduit. That is, the conduit 200 is closed along its length between the open ends 201, 202. The conduit 200 may have a tubular structure. The conduit 200 may include a tubular side wall 210. The tubular side wall 210 may have a circular cross-section, as shown, or may be any other shape, such as rectangular, square, oval, etc. The tubular side wall 210 extends from a first end 201 to a second end 202. The first end 201 may be a receiving end. The conduit 200 has a length L200 and an inner diameter D200. The length L200 may range from 20 cm to 65 cm, or from 30 cm to 50 cm. The inner diameter D200 may range from 5 cm to 15.5 cm, or from 7 cm to 12 cm.

In some embodiments, as shown in FIG. 7, the first end 2201 (e.g., the receiving end) of the conduit 2200 is shaped like a funnel. The funnel-shaped first end 2201 provides a wider inner diameter D2200 to ensure the accumulated material from the grill 50 is easily received in the conduit 2200.

In some preferred embodiments, the conduit 200 has a flexible structure. The conduit 200 may be flexible in the lateral (width-wise) direction. The conduit 200 may be flexible in the vertical (length-wise) direction. In some embodiments, the tubular side wall 210′ of the conduit 200′ has an accordion structure, as shown in FIG. 8. The accordion structure side wall 210′ may have a first length L201 and a second, extended length L202. The accordion structure side wall 210′ is shown schematically without other details but it should be understood that it may be combined with any of the other features discussed herein, including the various types of attachment mechanisms and the funnel-shaped receiving end.

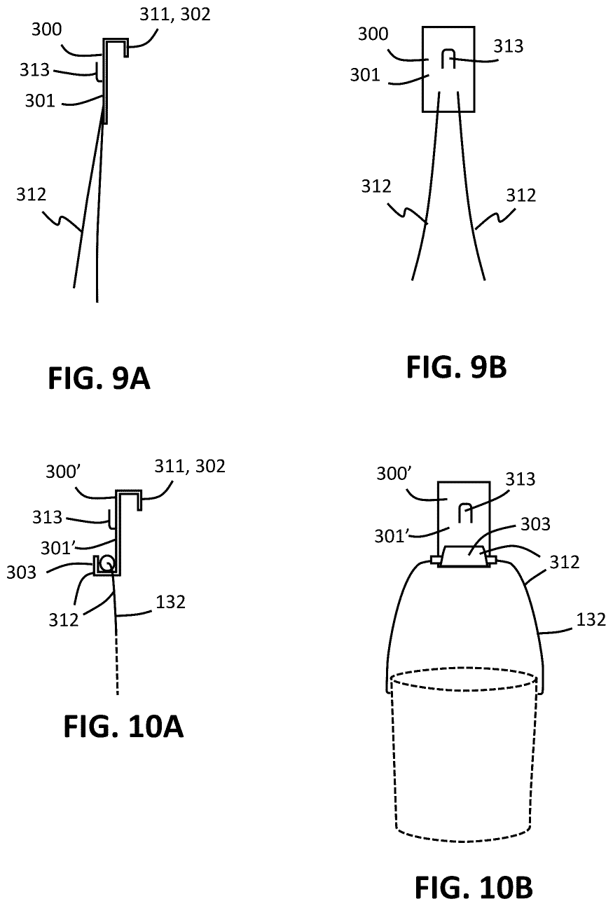

Various embodiments of the bracket and attachment mechanisms are shown in FIGS. 9A-11. The bracket 300 is constructed to couple the grease receptacle 100 and/or conduit 200 to the grill 50. The bracket 300 may include one or more attachment mechanisms that attach the bracket 300 to the grill 50 and attach one or both of the grease receptacle 100 and conduit 200 to the bracket 300 and thus, indirectly, to the grill 50.

As shown in FIGS. 9A and 9B, the bracket 300 may include a body 301 with a first attachment mechanism 311 for attaching the bracket 300 to the grill 50. The first attachment mechanism 311 may be a hook 302. The hook 302 may extend from the body 301 of the bracket 300. The hook 302 may be constructed to latch onto the grill 50. For example, the hook 302 may be constructed to latch onto the backside of the grill 50 at or below the opening 55 in the housing 52. The bracket 300 may include a second attachment mechanism 312 for attaching the bracket 300 to the grease receptacle 100. The second attachment mechanism 312 may include a chain, wire, or an extension of the bracket 300, or a combination thereof. The second attachment mechanism 312 may attach to brackets 118 or other attachments on the grease receptacle 100.

In some embodiments, such as that shown in FIGS. 10A and 10B, the second attachment mechanism 312 includes a second hook 303 at the lower end of the bracket body 301′ and a handle 132 on the grease receptacle 100. The handle 132 may be received in the second hook 303.

The bracket 300 may include a third attachment mechanism 313 for securing the receiving end (e.g., first end 201) of the conduit 200 to the bracket 300. The third attachment mechanism 313 is not particularly limited and may include one or more of a nut and bolt, a rivet, interlocking hooks, a hook and loop, a weld, or any other suitable mechanism. A corresponding attachment mechanism may be included on the conduit 200, configured to mate with the third attachment mechanism 313.

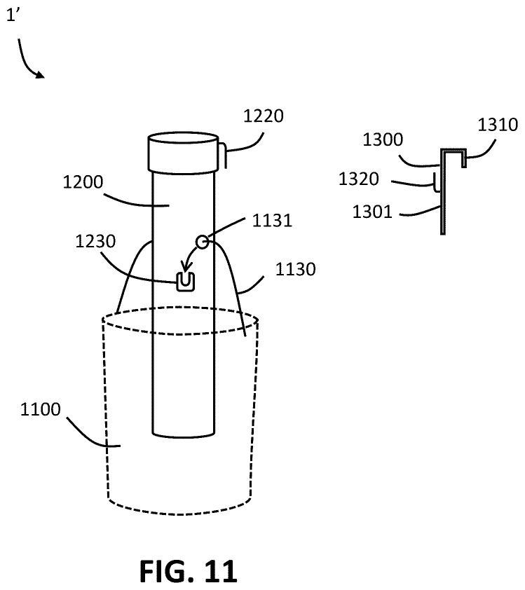

In some embodiments, shown in FIG. 11, the system 1′ includes a first attachment mechanism 1310 (such as a hook) extending from the bracket 1300 arranged to couple the bracket 1300 to the cooking grill 50. The bracket 1300 includes a second attachment mechanism 1320 extending from the bracket body 1301 and arranged to couple the conduit 1200 to the bracket 1300. The conduit 1200 may include a corresponding attachment mechanism 1220 constructed to couple with the second attachment mechanism 1320 on the bracket 1300. The system 1′ includes a third attachment mechanism 1230 disposed on or extending from the conduit 1200 and arranged to couple the grease receptacle 1100 to the conduit 1200. The third attachment mechanism 1230 may include two U-shaped slots each constructed to receive an end 1131 of an extension 1130 extending from the grease receptacle 1100. The two U-shaped slots may be positioned on opposite sides of the conduit 1200.

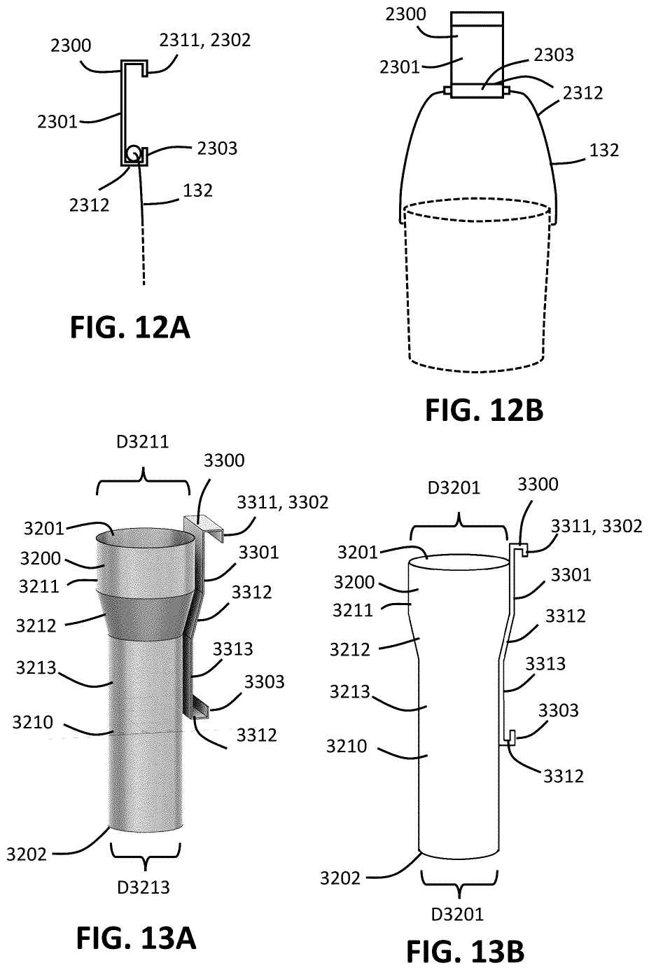

Another embodiment including a second hook 2303 is shown in FIGS. 12A and 12B. The second attachment mechanism 2312 includes a second hook 2303 at the lower end of the bracket body 2301. In this embodiment, the second hook 2303 and the first hook 2302 both face toward the back of the bracket 2300 (that is, toward the grill when the bracket is installed on the grill). The second hook 2303 is configured to receive the handle 132 of the grease receptacle 100.

The bracket 2300 may include a third attachment mechanism for securing the receiving end (e.g., first end 201) of the conduit 200 to the bracket 2300. The third attachment mechanism is not shown but may be similar to that in FIGS. 10A and 10B, and may include one or more of a nut and bolt, a rivet, interlocking hooks, a hook and loop, a weld, or any other suitable mechanism. A corresponding attachment mechanism may be included on the conduit, configured to mate with the third attachment mechanism.

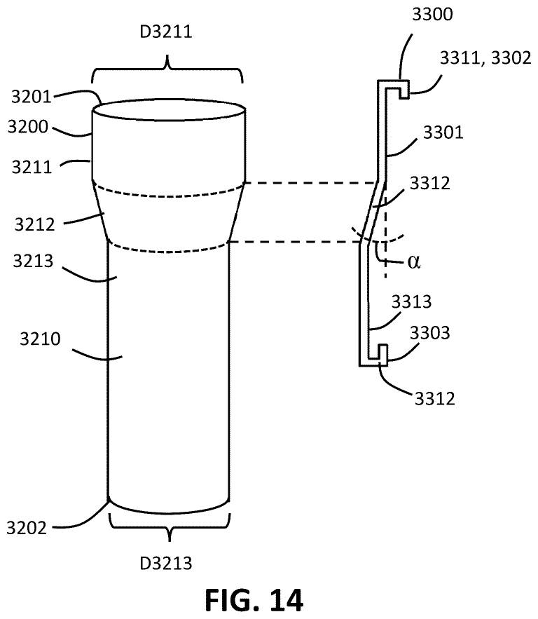

The embodiment of FIGS. 12A and 12B enables the bracket 2300 to be shaped to conform to the shape of the conduit, like the bracket 3300 and conduit 3200 shown in FIGS. 13A and 13B. This may be particularly useful in embodiments where the conduit has a varying diameter, such as when the conduit 3200 has a funnel-shaped upper section 3211, as shown in FIGS. 13A, 13B, and 14. Here, the conduit 3200 has an upper section 3211, an intermediate section 3212, and a lower section 3213. The upper section 3211 extends from the open first end 3201 to the intermediate section 3212. The lower section 3213 extends from the intermediate section 3212 to the open second end 3202. The upper section 3211 has a diameter D3211 that is larger than the diameter D3213 of the lower section 3213. The intermediate section 3212 tapers from the upper section 3211 to the lower section 3213. The intermediate section 3212 may be characterized as a funnel. The lower section 3213 may form the majority of the tubular side wall 3210.

The bracket 3300 may include corresponding upper section 3301, intermediate section 3312, and lower section 3313. The intermediate section 3312 may be an oblique section. The bracket 3300 may include a vertical upper section 3301 and an oblique section (e.g., intermediate section 3312) extending from the vertical upper section 3301. The bracket 3300 may further include a vertical lower section 3313 extending from the oblique section (e.g., intermediate section 3312). The upper, intermediate, and lower sections 3301, 3312, 3313 of the bracket 3300 may follow the same shape as the conduit 3200. The intermediate section 3312 may be disposed at an angle α between 5° and 45° (or between 5° and 30°) relative to a plane defined by the upper section 3301 (see FIG. 14).

The bracket 3300 further includes a first hook 3302 and a second hook 3303. The second hook 3303 and the first hook 3302 both face toward the back of the bracket 3300 (that is, toward the grill when the bracket is installed on the grill). The second hook 3303 is configured to receive the handle 132 of the grease receptacle 100. The oblique intermediate section 3312 and the second hook 3303 facing toward the back of the bracket 3300 enable the conduit 3200 to be mounted close to the bracket 3300 while making it easier to hang the receptacle handle into the second hook 3303. It may further allow the second end 3202 of the conduit 3200 to be arranged in a desired location in the receptacle. For example, the second end 3202 of the conduit 3200 may be arranged near the center axis of the receptacle or between the center axis and the back of the grill. This may help avoid inadvertent bumping or tipping of the receptacle.

The bracket 3300 may include a third attachment mechanism for securing the receiving end (e.g., first end 3201) of the conduit 3200 to the bracket 3300. The third attachment mechanism is not shown but may be similar to that of FIGS. 10A and 10B, and may include one or more of a nut and bolt, a rivet, interlocking hooks, a hook and loop, a weld, or any other suitable mechanism. A corresponding attachment mechanism may be included on the conduit, configured to mate with the third attachment mechanism. In one embodiment, the attachment mechanism is a rivet extending through the body of the bracket 3300 and the wall of the conduit 3200.

The first hook 3302 and the second hook 3303 may be sized suitably to fit the opening of the grill (the first hook 3302) and the handle 132 of the grease receptacle 100 (the second hook 3303). The first hook 3302 and the second hook 3303 may independently have a horizontal dimension (e.g., the size of the opening) in a range of 0.5 cm to 4 cm, 0.5 cm to 3 cm, 0.5 cm to 2.5 cm, or 1 cm to 2.5 cm. The first hook 3302 and the second hook 3303 may independently have a vertical dimension (e.g., the height of the hook) in a range of 0.5 cm to 4 cm, 0.5 cm to 3 cm, 0.5 cm to 2.5 cm, or 1 cm to 2.5 cm.

The bracket 300 and the attachment mechanisms may be positioned and sized suitably so that the grease receptacle 100 hangs at the desired height H100 above the ground or floor.

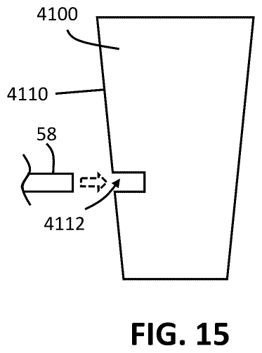

In some embodiments, the grease receptacle 100 may be constructed to be placed on and/or supported by a shelf 58 that is part of the cooking grill 50. This may allow the shelf 58 to support the weight of the grease receptacle 100 and any accumulated material inside the grease receptacle 100. Placing the grease receptacle 100 at least in part on the shelf 58 may also save space by allowing the cooking grill 50 to be placed against a wall or other structure. In some embodiments, as shown in FIG. 15, the grease receptacle 4100 may further be formed with a slot 4112 in its side wall 4110 to receive the shelf 58. This feature may be combined with the grease receptacle 4100 having a rectangular cross-sectional shape in a horizontal cross section as a further space-saving feature.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A grease management system comprising:
a grease receptacle comprising an interior and an opening;
an enclosed tubular conduit comprising an open receiving end and an open distal end and a length therebetween, the receiving end arranged to receive material from a cooking grill, and the distal end arranged to direct the material to the opening of the grease receptacle;
a bracket comprising a first attachment mechanism arranged to couple the receiving end to the cooking grill; and
a second attachment mechanism arranged to couple the grease receptacle to the bracket and the enclosed tubular conduit.

2. The grease management system of claim 1, wherein the open distal end of the enclosed tubular conduit extends through the opening of the grease receptacle.

3. The grease management system of claim 1, wherein the length of the enclosed tubular conduit is 20 cm to 65 cm and wherein the enclosed tubular conduit has an inner diameter of 5 cm to 15.5 cm.

4. The grease management system of claim 1, wherein the receiving end of the enclosed tubular conduit comprises a funnel.

5. The grease management system of claim 1, wherein the first attachment mechanism comprises a first hook or the second attachment mechanism comprises a second hook or both the first and second attachment mechanisms comprise a hook.

6. The grease management system of claim 5, wherein the grease receptacle comprises a handle and wherein the handle is constructed to be received by the second hook.

7. The grease management system of claim 1, wherein the second attachment mechanism is part of the bracket.

8. The grease management system of claim 1, wherein the first attachment mechanism comprises a first hook extending from a first side of the bracket, and the second attachment mechanism comprises a second hook extending from the first side of the bracket, and wherein the enclosed tubular conduit is coupled to a second side of the bracket opposite of the first side.

9. The grease management system of claim 8, wherein the bracket comprises a body comprising:
an upper end and a lower end, the first hook extending from the upper end, and the second hook extending from the lower end;
an upper section extending from the upper end toward the lower end;
an intermediate section extending from the upper section, the intermediate section being an oblique section; and
a lower section extending from the intermediate section to the lower end.

10. The grease management system of claim 9, wherein the receiving end of the enclosed tubular conduit comprises a funnel comprising an oblique section, and wherein the oblique section of the funnel is disposed at the same angle as the oblique section of the bracket.

11. The grease management system of claim 1, wherein the first attachment mechanism extends in a first direction from the bracket, and the open receiving end of the conduit extends in a second direction opposite of the first direction.

12. The grease management system of claim 1, wherein the enclosed tubular conduit is flexible.

13. The grease management system of claim 12, wherein the enclosed tubular conduit has an accordion structure.

14. The grease management system of claim 1, wherein the enclosed tubular conduit or the grease receptacle or both are constructed of a polymer.

15. The grease management system of claim 1, wherein the grease receptacle comprises a disposable liner.

16. The grease management system of claim 1, wherein the second attachment mechanism is disposed on or extends from the enclosed tubular conduit and is arranged to couple the grease receptacle to the enclosed tubular conduit.

17. The grease management system of claim 16, wherein the second attachment mechanism comprises a U-shaped slot constructed to receive an end of an extension extending from the grease receptacle.

18. The grease management system of claim 16, wherein the second attachment mechanism comprises a lid constructed to couple with the opening of the grease receptacle.

19. A method of using a grease management system comprising:
a grease receptacle comprising an interior, an opening, and a handle;
an enclosed tubular conduit comprising an open receiving end and an open distal end and a length therebetween; and
a bracket comprising a first attachment mechanism; and
a second attachment mechanism,
the method comprising:
coupling the first attachment mechanism with a cooking grill to arrange the receiving end to receive material from the cooking grill, and
coupling the handle of the grease receptacle with the second attachment mechanism, such that the open distal end of the enclosed tubular conduit extends through the opening of the grease receptacle.

20. The method of claim 19, further comprising directing accumulated material from the cooking grill into the open receiving end of the enclosed tubular conduit.
